(19) United States
(12) Patent Application Publication
(10) Pub. No.: US 2011/0284326 A1
(43) Pub. Date: Nov. 24, 2011

(54) METHOD AND APPARATUS FOR USE IN LINING A CURVED WALL

(76) Inventors: Christos S. Haritou, Cleveland (GB); Alan Fada, Tyne & Wear (GB); Ian Gimiel Fada, Tyne & Wear (GB); John Harry Rhodes, Tyne & Wear (GB); Julie Rhodes, Tyne & Wear (GB)

(21) Appl. No.: 12/671,748

(22) PCT Filed: Aug. 4, 2008
(86) PCT No.: PCT/GB08/50658

§ 371 Date: Aug. 8, 2011

(30) Foreign Application Priority Data
Aug. 2, 2007 (GB) 0715027.9

(51) Int. Cl. E04G 1/36; B23P 17/00

(52) U.S. Cl. 182/132; 29/428

(57) ABSTRACT

Apparatus for use in lining a curved wall comprising staging (5), which staging includes a deck (6) and anchor plates (7, 7a) attached at opposing. ends of the deck (6), wherein the anchor plates (7, 7a) are attached to the deck (6) by respective pivots such that, in use, the anchor plates (7, 7a) engage with the surface of the wall (4) and wherein a line extending between the ends of the anchor plate (7, 7a) forms a chord to the curve of the wall.

### FIELD OF THE INVENTION

This invention relates to an apparatus and method for lining a curved wall, and in particular to an apparatus and method for lining a tank having a substantially cylindrical cross-section with a smooth surface lining material.

### BACKGROUND OF THE INVENTION

An apparatus and method for lining a tank is described in United Kingdom patent application no 0409466.0. This application is concerned with lining inter alia fuel storage tanks with plastics liners. It is vital that the lining does not leak and therefore any work done whilst lining the tank must not compromise the plastics or composite lining material (or individual layers of a composite lining material), for example where a tank is being lined with a liner of the type described in GB 0619254.6.

Tanks can be of a diameter that would preclude the fitting of a lining of the type described in GB 0409466.0 or GB 0619254.6 without some kind of staging to provide a working platform at a suitable distance from the tank wall to be lined.

United Kingdom patent application number 0419829.7 discloses an apparatus for use in lining the curved wall of a tank. Feet rest on the inner wall of the tank to support the staging and the feet are prevented from sliding around the tank by magnets attached to the ferrous tank wall.

The present invention is concerned with the provision of staging, which does not require the use of magnets, a method of securing the staging in a working environment, and a method of lining a tank utilising such staging.

### SUMMARY OF THE INVENTION

The invention provides apparatus for use in lining a curved wall, the apparatus comprising staging, which staging includes a deck and anchor plates attached at opposing ends of the deck, wherein the anchor plates are attached to the deck by respective pivots wherein the anchor plates are adapted to engage with a curved surface associated with, and corresponding to the shape of the wall and wherein a force transmitted from the deck to the anchor plates through the pivots generates friction forces between the anchor plates and said curved surface, said friction forces supporting the deck with respect to the curved wall.

The deck includes bores, through which the anchor plates may be removably attached to the deck using pins. The pins provide the pivot for anchor plates. The angle at which the anchor plates are positioned with respect to the longitudinal plane of the deck, in use, will vary according to the radius of the tank.

In use the anchor plates of the staging may rest on either the inner wall of the tank, or a lining applied to the inner wall of the tank.

When the staging is positioned in the tank, the anchor plates pivot such that the downward force of the staging and any object supported thereon, and in particular between the pivot attachment of the anchor plates to the staging, causes the anchor plates to adopt a position in which the force on each anchor plate is substantially perpendicular to its base. This provides stability to the staging and prevents the staging from rotating around the curved wall.

The base surfaces of the anchor plates may be provided with resilient material.

The invention further comprises a method of supporting an object above a curved wall having a smooth surface, the method comprising the step of mounting the staging of the invention in the tank.

The invention further provides a method of lining a tank utilising the staging of the invention, the method comprising mounting the staging in a tank to be lined, and using the staging as a working platform.

### BRIEF DESCRIPTION OF THE DRAWINGS

In the drawings, which illustrate a preferred embodiment of the invention, and are by way of example only:

FIG. 1 shows a cross-sectional view of a tank being lined, with staging according to the invention mounted therein;

FIG. 2 is a schematic representation of an anchor plate of the staging of FIG. 1; and

FIG. 3 is a schematic representation of the deck of the staging of FIG. 1.

### DETAILED DESCRIPTION OF THE DRAWINGS

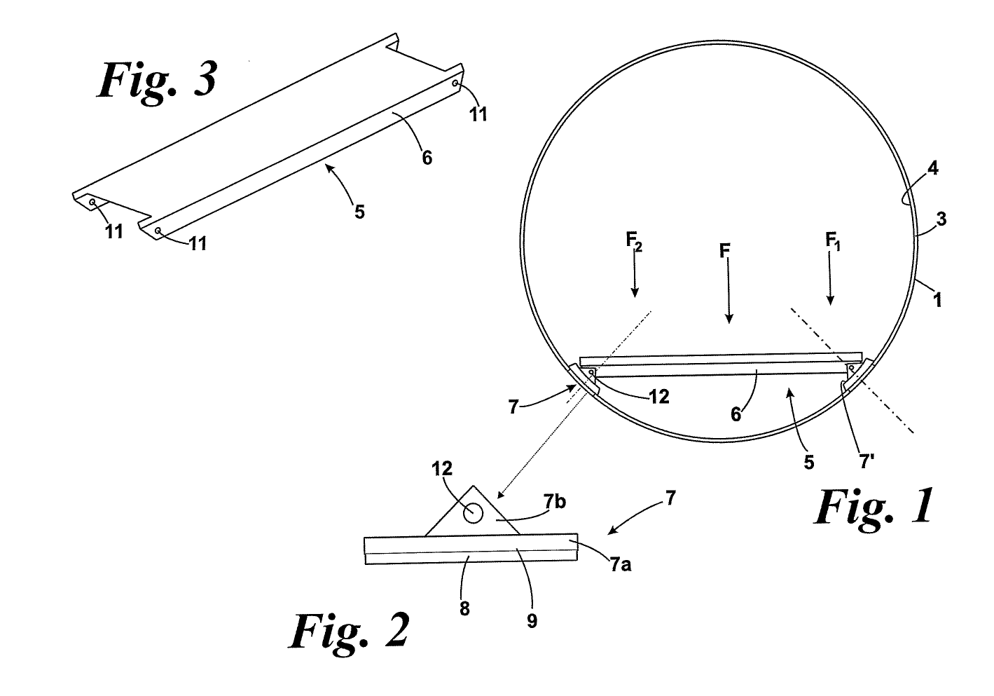

In FIG. 1, there is shown a tank comprising a steel shell 1 coated with an epoxy resin 2. An interstitial space is provided between the inwardly facing surface of the epoxy layer and a layer 4 of plastics material forming the inner lining ultimately having contact with fuel stored in the tank. The layer 4 may be a layer of a composite lining material, for example a layer of lining material as described in GB 0619254.6.

Referring now to FIGS. 1 to 3, the staging 5 comprises a deck 6, the ends of which are attached to anchors 7 by pins which pass through bores 11 in the deck and bores 12 in brackets 7b of the anchors 7. The deck 6 and anchor 7 may be made of steel, aluminium, timber or any other suitable material.

The anchors 7 pivot to form an angle to the longitudinal plane of the deck 6, the angle being determined by the radius of the curvature of the tank wall.

In the example illustrated, the anchors 7 comprise plates 7a which are provided with a cushioned liner 8 formed from a resilient material, such as rubber padding bonded to the base 9 of each plate 7a. The cushioned liner 8 serves a number of purposes. First, the cushioned liner deforms under the weight of the staging and any personnel thereon, thereby providing a greater surface area of material in contact with the inner surface of the tank than would be the case if the two ends of the plate 7a were in contact with said surface. The load is therefore distributed over a larger area and where the plates 7a rest on the lining material 4 the likelihood of damage thereto is reduced. Second, the liner 8 has a greater co-efficient of friction that the material of the plates 7a, thereby increasing the stability of the staging in the tank.

One problem with mounting staging on a curved surface is that if a load on the staging is not located substantially centrally between the anchor points on the curved surface, there is a risk that the staging will slide around the tank. This would obviously be exceedingly dangerous. In the prior art this problem was solved by anchoring the staging in place with magnets.

The present invention solves this problem by the construction of the anchors 7 and the manner in which the anchors 7 are attached to the deck 6. By providing for pivotal movement between the anchors 7 and the deck 6, a force exerted on the deck 6 generates a reaction force through the pivot point. The anchors 7 are forced against the tank shell 1. The pivotal attachment of the anchors 7 to the deck 6 allows the staging to be used in tanks of different diameters. Further, the deck may be extensible in order to facilitate mounting the staging in curved walls of different diameters, or to change the working height within a given curved wall. Extension means may comprise a telescopic deck. What is required for the staging to be functional in tanks of different diameters is for the pivot 12 to lie to the outside of the inner edge 7′ of the anchor 7 and the object on the staging to lie between the pivots 12. As long as this configuration is maintained, the staging cannot tip with respect to either of the anchors 7 as each the anchor is always being urged downward by the force F₁.

In the case where a worker stands in the centre of the deck 6 a force F is exerted thereon, and this force will be distributed evenly over the two anchors 7 so that F₁ and F₂ are substantially equal. When the worker moves to the right F₁ will increase and F₂ will decrease, and vice versa when the worker moves to the left of centre. As the worker moves to the right, increasing F₁, the distance at which the force F₁ is applied to the staging with respect to the pivot mounting of the right hand anchor decreases such that the moment about the pivot remains substantially constant. Similarly, F₂ will decrease, but the distance at which F₂ is applied to the left hand pivot is increased such that the moment about the left hand pivot remains substantially constant, except when all the force is at one or other ends of the deck 6.

As the force F₁ increases the friction generated between the surface of the anchor 7 and the curved wall increases, thereby causing the staging to resist slipping with respect to the inner wall of the tank. Similarly, if the load moves to the left, increasing F₂ the resistance to slippage between the corresponding anchor 7 and the curved wall of the tank increases.

In the present invention, even if the load on the staging is not located centrally between the anchors 7 the staging has been found not shift.

1. Apparatus for use in lining a curved wall, the apparatus comprising
staging, which staging includes a deck and anchor plates attached at opposing ends of the deck, wherein the anchor plates are attached to the deck by respective pivots
wherein the anchor plates are adapted to engage with a curved surface associated with, and corresponding to the shape of, the wall and
wherein a force transmitted from the deck to the anchor plates through the pivots generates friction forces between the anchor plates and said curved surface,
said friction forces supporting the deck with respect to the curved wall.

2. Apparatus according to claim 1, wherein the inner edges of the anchors lie inside the pivots.

3. Apparatus according to claim 1, wherein the outer edges of the anchors lie outside the pivots.

4. Apparatus according to claim 3, wherein, in use, the outer edges lie outside the ends of the deck.

5. Apparatus according to claim 1, wherein the surfaces of the anchors facing the inner wall are provided with a resilient material.

6. Apparatus according to claim 1, wherein the surfaces of the anchors are provided with a material having a high co-efficient of friction.

7. Apparatus according to claim 1, wherein the anchors are removably attached to the deck by pins, each pin forming a respective one of the pivots.

8. Apparatus according to claim 1, including means to extend the distance between the surfaces of the anchors engaging the curved wall.

9. Apparatus according to claim 8, wherein the means to extend the distance between the surfaces of the anchors engaging the curved wall is provided by an extendible deck.

10. A method of mounting apparatus according to claim 1 on a curved wall comprising mounting the staging on the curved wall and holding the apparatus in place by friction forces generated between the anchors and the surface on which the anchors rest.

11. A method of lining a tank utilizing a staging, which staging includes a deck and anchor plates attached at opposing ends of the deck, wherein the anchor plates are attached to the deck by respective pivots wherein the anchor plates are adapted to engage with a curved surface associated with, and corresponding to the shape of, the wall and wherein a force transmitted from the deck to the anchor plates through the pivots generates friction forces between the anchor plates and said curved surface, said friction forces supporting the deck with respect to the curved wall, the method comprising mounting the staging in a tank to be lined according to the method of claim 10, and using the staging as a working platform.

12. (canceled)
